(19) United States
(12) Patent Application Publication
(10) Pub. No.: US 2015/0039263 A1
(43) Pub. Date: Feb. 5, 2015

(54) ELECTRONIC APPARATUS AND PROGRAM

(71) Applicant: SEIKO INSTRUMENTS INC., Chiba-shi (JP)

(72) Inventors: Takanori HASEGAWA, Chiba-shi (JP); Akira TAKAKURA, Chiba-shi (JP); Keisuke TSUBATA, Chiba-shi (JP); Kazuo KATO, Chiba-shi (JP); Hisao NAKAMURA, Chiba-shi (JP); Tomohiro IHASHI, Chiba-shi (JP); Katsuya MUGISHIMA, Chiba-shi (JP)

(21) Appl. No.: 14/444,933

(22) Filed: Jul. 28, 2014

(30) Foreign Application Priority Data
Jul. 31, 2013 (JP) 2013-158698

(51) Int. Cl. G01C 5/00

(52) U.S. Cl. CPC G01C 5/00
USPC 702/166

(57) ABSTRACT

An electronic apparatus includes a display unit, an altitude measurement unit that measures an altitude, key input means for receiving an operation input, and a CPU that starts recording of altitude information regarding an altitude measured by the altitude measurement unit at a predetermined time interval if the key input means receives an input for instructing starting of recording of an altitude, stops the recording of the altitude information if the key input means receives an input for instructing stopping of recording of an altitude, and displays the altitude information when the recording starts on the display unit if the key input means receives an input for instructing display of the altitude information in a state in which the altitude information is currently recorded.

### BACKGROUND OF THE INVENTION

1. Field of the Invention

The present invention relates to an electronic apparatus and a program.

2. Background Art

In the related art, there is an electronic apparatus or an electronic timepiece for mountain climbing which starts measuring an altitude and time, and displays an elapsed time, an altitude, or a change in the altitude during mountain climbing if a user operates a button. The user utilizes the displayed information for a climbing pace or planning. Japanese Patent No. 03027952 discloses an electronic timepiece which is set in an alti-chrono mode in which altitude measurement and a stop watch function are performed in the same mode, displays the elapsed time from the start, and simultaneously displays a relative altitude difference from the start. In addition, Japanese Patent No. 03269194 discloses an electronic timepiece which performs altitude measurement and a stop watch function in the same mode, and simultaneously displays the elapsed time and a relative altitude difference from the start.

During mountain climbing, not only information on the elapsed time, the present altitude, an amount of change in an altitude, and the like is effective, but also information on an altitude or a time point at a start time is important. For example, in a case of not only ascending but also descending from a peak, if information on an altitude or a time point at a start time is grasped during the descending, it is possible to grasp how much longer it will take to return to a starting location by comparing the altitude or the time point at a start time with the present altitude or time. In addition, it is possible to grasp that the present location is not too lower than the starting location by comparing an altitude of the starting location with the present altitude.

In the techniques disclosed in Japanese Patent Nos. 03027952 and 03269194, the elapsed time from the start or the present altitude, or an amount of change in the altitude from the start is measured and displayed. For this reason, in order to grasp an altitude or a time point at a start time, a user is required to calculate the altitude or the time point at a start time for himself/herself on the basis of information on the present time or altitude and the elapsed time from the start time or a relative altitude difference, and thus it is not possible to instantaneously grasp accurate information related to the start time during mountain climbing.

### SUMMARY OF THE INVENTION

It is an aspect of the present application to provide an electronic apparatus and a program capable of displaying altitude information of a predetermined location which a user has passed during mountain climbing.

According to another aspect of the present application, there is provided an electronic apparatus including a display unit; an altitude measurement unit that measures an altitude; an operation unit that receives an operation input; a recording unit that starts recording of altitude information regarding an altitude measured by the altitude measurement unit at a predetermined time interval if the operation unit receives an input for instructing starting of recording of an altitude, and stops the recording of the altitude information if the operation unit receives an input for instructing stopping of recording of an altitude; and a display control unit that displays the altitude information when the recording starts on the display unit among the altitude information pieces recorded by the recording unit if the operation unit receives an input for instructing display of the altitude information in a state in which the recording unit currently records the altitude information.

In addition, in the electronic apparatus according to another aspect of the present application, the display control unit may display a climbing speed which is a movement speed regarding an altitude calculated from the altitude information recorded by the recording unit on the display unit if the operation unit receives an input for instructing display of the altitude information in a state in which the recording unit currently records the altitude information.

Further, in the electronic apparatus according to another aspect of the present application, the climbing speed may include an average climbing speed regarding an ascending state or an average climbing speed regarding a descending state.

In addition, in the electronic apparatus according to another aspect of the present application, the display control unit may display altitude information indicating a maximal altitude or altitude information indicating a minimal altitude on the display unit among the altitude information pieces recorded by the recording unit if the operation unit receives an input for instructing display of the altitude information in a state in which the recording unit currently records the altitude information.

Further, in the electronic apparatus according to another aspect of the present application, the recording unit may record the present altitude information as the altitude information of a point location if the operation unit receives an input for instructing recording of the altitude information of the point location, and the display control unit may display the altitude information of the point location on the display unit if the operation unit receives an input for instructing display of the altitude information in a state in which the recording unit currently records the altitude information.

According to another aspect of the present application, there is provided a program causing a computer to perform measuring an altitude; starting recording of altitude information regarding the measured altitude at a predetermined time interval if an operation unit which receives an operation input receives an input for instructing starting of recording of an altitude; recording the present altitude information as the altitude information of a point location if the operation unit receives an input for instructing recording of the altitude information of the point location; displaying the altitude information when the recording starts, a climbing speed which is a movement speed regarding an altitude calculated from the altitude information, the altitude information indicating a maximal altitude among the altitude information pieces, the altitude information indicating a minimal altitude among the altitude information pieces, or the altitude information of the point location on a display unit if the operation unit receives an input for instructing display of the altitude information in a state in which the altitude information is currently recorded; and stopping the recording of the altitude information if the operation unit receives an input for instructing stopping of recording of an altitude.

According to the aspects of the present application, the altitude information regarding an altitude measured at a predetermined time interval is recorded if the operation unit receives an input for instructing starting of recording of an altitude, and the altitude information when the recording starts is displayed on the display unit if the operation unit receives an input for instructing display of the altitude information in a state in which the altitude information is currently recorded. Accordingly, it is possible to display altitude information of a predetermined location which a user has passed during mountain climbing. For example, since recording of altitude information starts from a starting location if an input operation of instructing starting of recording of an altitude at the starting location of mountain climbing is performed on the operation unit, it is possible to display altitude information of the starting location when an input operation of instructing display of the altitude information when the recording starts is performed on the operation unit.

### BRIEF DESCRIPTION OF THE DRAWINGS

FIG. 1 is a front view illustrating an exterior configuration of an electronic apparatus according to a first embodiment of the present invention.

FIG. 2 is a block diagram illustrating a configuration of the electronic apparatus according to the first embodiment.

FIG. 3 is a schematic diagram illustrating information which is displayed by a display unit in an altitude log mode in the first embodiment.

FIG. 4 is a schematic diagram illustrating information regarding a starting location which is displayed by the display unit in the first embodiment.

FIGS. 5A and 5B are schematic diagrams illustrating information regarding MAX/MIN which is displayed by the display unit in the first embodiment.

FIGS. 6A to 6C are schematic diagrams illustrating information regarding a point location which is displayed by the display unit in the first embodiment.

FIG. 7 is a flowchart illustrating a process procedure of an altitude recording process performed by the electronic apparatus according to the first embodiment.

FIGS. 8A to 8G are schematic diagrams illustrating a screen transition of a display unit in a second embodiment.

### DETAILED DESCRIPTION OF THE INVENTION

Hereinafter, embodiments of the present invention will be described with reference to the drawings. In addition, in the respective drawings, the same parts are given the same reference numerals.

### First Embodiment

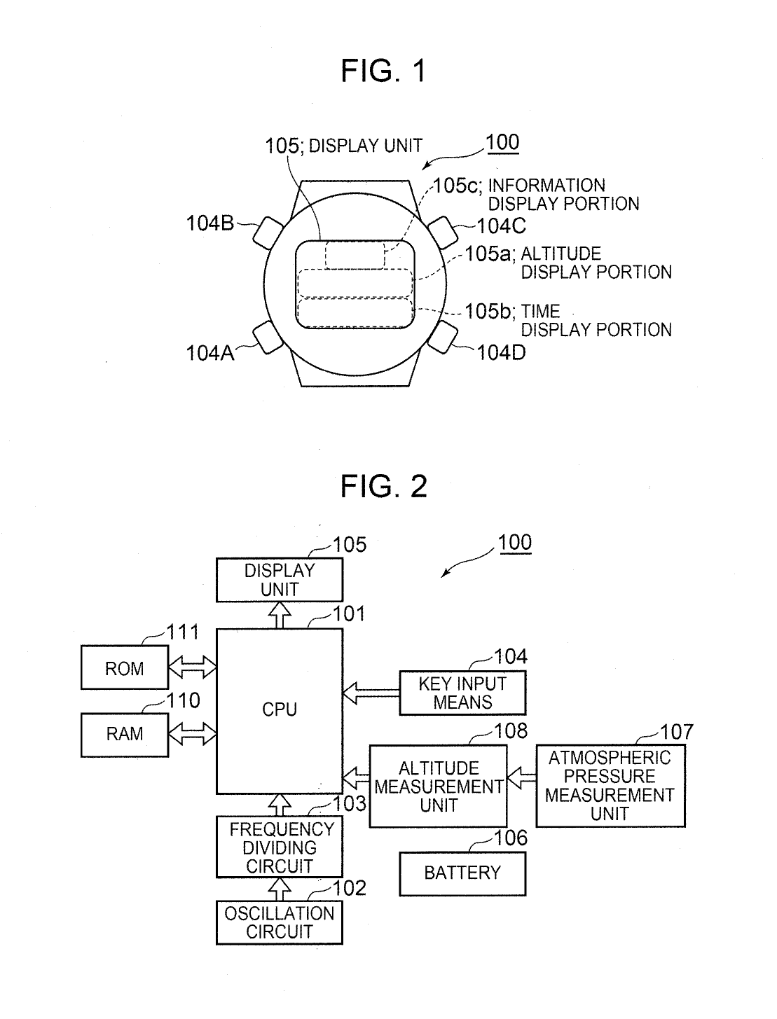

First, a first embodiment of the present invention will be described. FIG. 1 is a front view illustrating an exterior configuration of an electronic apparatus 100 according to the present embodiment. The electronic apparatus 100 is an electronic timepiece having an altitude measurement function. The electronic apparatus 100 operates in either of two types of operation mode including a normal mode in which an altitude and the present time (or the present date and time) are measured and displayed, and an altitude log mode in which altitude information regarding an altitude during mountain climbing is recorded.

When the electronic apparatus 100 operates in the normal mode, a measured altitude and the present time are displayed. In addition, when the electronic apparatus 100 operates in the altitude log mode, a relative altitude difference from a starting location, a measured altitude, and the present time are displayed. Further, when the electronic apparatus 100 operates in the altitude log mode, a measured altitude and the present time are recorded in a log file as altitude information at a predetermined time interval (for example, one minute). A user changes a mode of the electronic apparatus 100 from the normal mode to the altitude log mode at a starting location where the user starts climbing a mountain. In addition, the user changes a mode of the electronic apparatus 100 from the altitude log mode to the normal mode at an end location where the user ends the climbing. Accordingly, it is possible to record the altitude information during mountain climbing in the log file. As illustrated in FIG. 1, the electronic apparatus 100 includes a plurality of (in the present embodiment, four) key input means 104A to 104D, and a display unit 105.

The key input means 104A to 104D (operation unit) receive an operation input. For example, the key input means 104A receives an operation input (a log start operation (an input for instructing starting of recording of an altitude) or a log stopping operation (an input for instructing stopping of recording of an altitude)) for changing an operation mode. In addition, the key input means 104B receives an operation input (starting location display operation) for instructing display of altitude information (altitude and time) of a starting location (at the time of starting of recording) in the altitude log mode. Further, the key input means 104C receives an operation input (MAX location display operation) for instructing display of altitude information indicating a maximal altitude among altitude information pieces recorded in the log file or an operation input (MIN location display operation) for instructing display of altitude information indicating a minimal altitude thereamong. Furthermore, the key input means 104D receives an operation input (point location registration operation) for instructing recording of altitude information of a point location and an operation input (point location display operation) for instructing display of altitude information at the point location. In addition, the operation unit which receives the operation inputs may be formed by a plurality of key input means 104 and may be formed by a single key input means 104.

In the present embodiment, the electronic apparatus 100 changes an operation mode from the normal mode to the altitude log mode in a case where the key input means 104A receives an input when the electronic apparatus operates in the normal mode. In addition, the electronic apparatus 100 changes an operation mode from the altitude log mode to the normal mode in a case where the key input means 104A receives an input when the electronic apparatus operates in the altitude log mode. Further, the electronic apparatus 100 displays altitude information of a starting location in a case where the key input means 10413 receives an input when the electronic apparatus operates in the altitude log mode. Furthermore, the electronic apparatus 100 alternately displays altitude information indicating a maximal altitude and altitude information indicating a minimal altitude among altitude information pieces which are recorded in the log file in a case where the key input means 104C receives an input when the electronic apparatus operates in the altitude log mode.

In addition, the electronic apparatus 100 records the present altitude information in a log file as altitude information of a point location in a case where the key input means 104D receives a long-pressed input when the electronic apparatus operates in the altitude log mode. Further, the electronic apparatus 100 displays altitude information of the registered point location in a case where the key input means 104D receives a short-pressed input when the electronic apparatus operates in the altitude log mode. Furthermore, the long-pressed input indicates an input when the key input means 104 is pressed for a predetermined time (for example, two seconds) or more. Moreover, the short-pressed input indicates an input when the key input means 104 is pressed for below a predetermined time (for example, two seconds).

The display unit 105 is a liquid crystal display or a segment display, and displays information. The display unit 105 includes an altitude display portion 105a (upper display portion) for displaying an altitude, a time display portion 105b (lower display portion) for displaying time, and an information display portion 105c for displaying various information.

FIG. 2 is a block diagram illustrating a configuration of the electronic apparatus 100 according to the present embodiment. In an illustrated example, the electronic apparatus 100 includes a central processing unit (CPU) 101 (a display control unit and a recording unit), an oscillation circuit 102, a frequency dividing circuit 103, the key input means 104, the display unit 105, a battery 106, an atmospheric pressure measurement unit 107, an altitude measurement unit 108, a random access memory (RAM) 110 (storage unit), and a read only memory (ROM) 111.

The CPU 101 controls each unit of the electronic apparatus 100. For example, when the key input means 104A receives an input (an input for instructing starting of recording of an altitude) in the normal mode, the CPU 101 changes an operation mode to the altitude log mode so that altitude information (altitude and time) regarding an altitude is written to and recorded in a log file of the RAM 110 at a predetermined time interval (recording of altitude information at a predetermined time interval starts). In addition, when the key input means 104A receives an input (an input for instructing stopping of recording of an altitude) during an operation in the altitude log mode, the CPU 101 stops recording of altitude information and changes an operation mode to the normal mode.

Further, when the key input means 104B receives an input (an input for instructing display of altitude information when log recording starts) during an operation in the altitude log mode (in a state in which altitude information is currently recorded), the CPU 101 reads altitude information of a starting location (at the time of starting of log recording) from the log file stored in the RAM 110, and displays the read altitude information on the display unit 105. Furthermore, when the key input means 104C receives an input (an input for instructing display of altitude information regarding the maximum altitude), the CPU 101 reads altitude information in which an altitude is the highest from the log file among altitude information pieces recorded in the log file, and displays the read altitude information on the display unit 105. Moreover, when the key input means 104C receives an input (an input for instructing display of altitude information regarding the minimum altitude) again, the CPU 101 reads altitude information in which an altitude is the lowest from the log file among altitude information pieces recorded in the log file, and displays the read altitude information on the display unit 105.

When the key input means 104D receives a long-pressed input (an input for instructing recording of altitude information of a point location) during an operation in the altitude log mode, the CPU 101 writes the present altitude information to the log file as altitude information of the point location. In addition, when the key input means 104D receives a short-pressed input (an input for instructing display of altitude information of a point location), the CPU 101 reads altitude information of a point location from the log file, and displays the read altitude information on the display unit 105.

The CPU 101 counts the present time on the basis of a measurement signal which is input from the frequency dividing circuit 103, and displays the present time on the display unit 105. In addition, the CPU 101 displays an altitude input from the altitude measurement unit 108 on the display unit 105.

The oscillation circuit 102 generates an oscillation signal with a predetermined frequency (for example, 32768 Hz), and outputs the signal to the frequency dividing circuit 103. The frequency dividing circuit 103 divides the frequency of the oscillation signal which is input from the oscillation circuit 102 so as to generate a measurement signal which is used as a reference of measurement, and outputs the generated measurement signal to the CPU 101. The key input means 104 (104A to 104D) receives an operation input. The battery 106 supplies power for an operation to each unit of the electronic apparatus 100.

The atmospheric pressure measurement unit 107 is, for example, an atmospheric pressure sensor, and measures an atmospheric pressure, and outputs the measured atmospheric pressure to the altitude measurement unit 108. The altitude measurement unit 108 measures an altitude on the basis of the atmospheric pressure input from the atmospheric pressure measurement unit 107, and outputs the measured altitude to the CPU 101. The atmospheric pressure measurement unit 107 and the altitude measurement unit 108 form an altimeter which measures an altitude.

The RAM 110 stores data used by each part of the electronic apparatus 100. For example, the RAM 110 stores a log file indicating altitude information regarding an altitude. The ROM 111 stores an operation program executed by the CPU 101 in advance. The operation program is read when the CPU 101 starts.

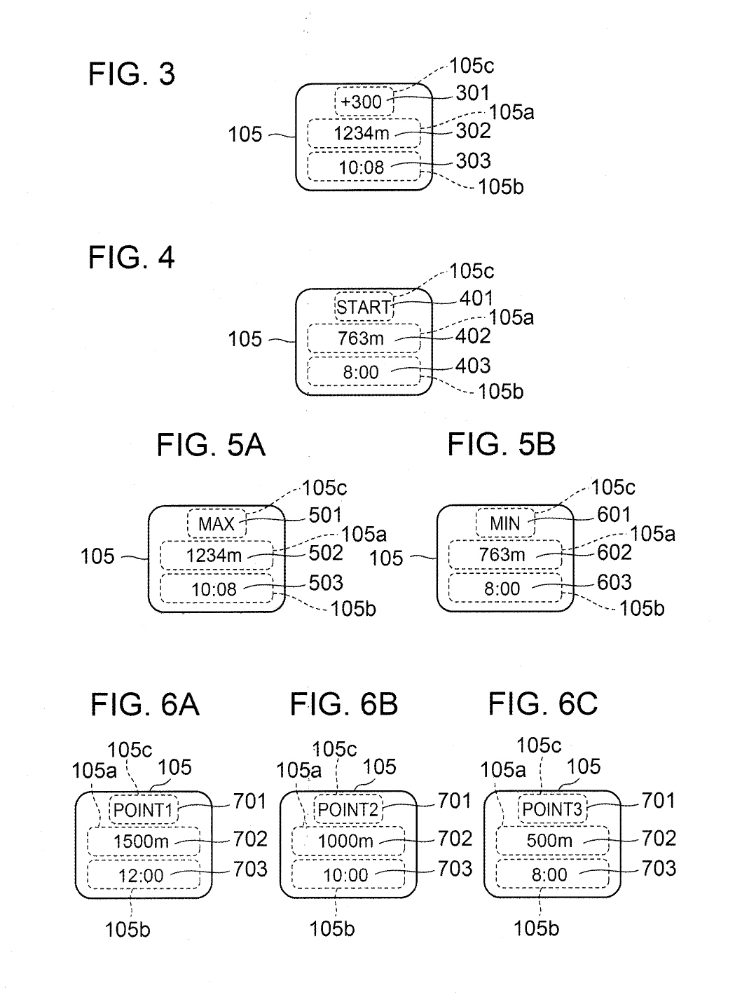

Next, a description will be made of information which is displayed by the display unit 105. FIG. 3 is a schematic diagram illustrating information which is displayed in the altitude log mode by the display unit 105 according to the present embodiment. In an illustrated example, the display unit 105 displays the present altitude “1234 m” 302 on the altitude display portion 105a, displays the present time “10:08” 303 on the time display portion 105b, and displays a relative altitude difference “+300 m” 301 between the present altitude and an altitude of a starting location (at the time of starting of log recording) on the information display portion 105c. Here, “+” displayed in the relative altitude difference indicates that the present altitude is higher than an altitude of a starting location, and “−” indicates that the present altitude is lower than the altitude of the starting location.

FIG. 4 is a schematic diagram illustrating information regarding a starting location displayed by the display unit 105 according to the present embodiment. If the key input means 104B receives an input when the display illustrated in FIG. 3 is performed, the display unit 105 displays altitude information of the starting location as illustrated in FIG. 4. In an illustrated example, the display unit 105 displays an altitude “763 m” 402 of the starting location on the altitude display portion 105a, displays a time point “8:00” 403 at the starting location on the time display portion 105b, and displays “START” 401 indicating that the altitude information of the starting location is displayed, on the information display portion 105c. In addition, in a case where the key input means 104B receives an input again when the illustrated display is performed, or in a case where a predetermined time has elapsed after the illustrated display starts, the display unit 105 performs the display illustrated in FIG. 3.

FIGS. 5A and 5B are schematic diagrams illustrating information regarding MAX/MIN which is displayed by the display unit 105 according to the present embodiment. If the key input means 104C receives an input in the normal mode or when the display illustrated in FIG. 3 is performed, the display unit 105 displays altitude information of a MAX location as illustrated in FIG. 5A. The altitude information of a MAX location is altitude information indicating the highest altitude among altitude information pieces recorded in the log file. In the illustrated example, the display unit 105 displays an altitude “1234 m” 502 of the MAX location on the altitude display portion 105a, displays a time point “10:08” 503 at the MAX location on the time display portion 105b, and displays “MAX” 501 indicating that altitude information of the MAX location is displayed, on the information display portion 105c.

In addition, if the key input means 104C receives an input when the display illustrated in FIG. 5A is performed, the display unit 105 displays altitude information of a MIN location as illustrated in FIG. 5B. The altitude information of a MIN location is altitude information indicating the lowest altitude among altitude information pieces recorded in the log file. In the illustrated example, the display unit 105 displays an altitude “763 m” 602 of the MIN location on the altitude display portion 105a, displays a time point “8:00” 603 at the MIN location on the time display portion 105b, and displays “MIN” 601 indicating that altitude information of the MIN location is displayed, on the information display portion 105c.

In addition, in a case where the key input means 104C receives an input when the display illustrated in FIG. 5A or 5B is performed, or in a case where a predetermined time has elapsed after the display illustrated in FIG. 5A or 5B starts, the display unit 105 performs the display illustrated in FIG. 3.

Further, in the present embodiment, the CPU 101 displays altitude information of a MAX location or a MIN location if the key input means 104C receives an input, but a MAX location display operation and a MIN location display operation are not limited thereto. For example, the CPU 101 may display altitude information of a MAX location if the key input means 104B receives an input when the display illustrated in FIG. 4 is performed, and may display altitude information of a MIN location if the key input means 104B receives an input again. In other words, the CPU 101 displays altitude information of a starting location if the key input means 104B receives a first input, displays altitude information of a MAX location if the key input means 104B receives a second input, and displays altitude information of a MIN location if the key input means 104B receives a third input.

FIGS. 6A to 6C are schematic diagrams illustrating information regarding a point location displayed by the display unit 105 according to the present embodiment. If the key input means 104D receives a short-pressed input in the normal mode or when the display illustrated in FIG. 3 is performed, the display unit 105 displays altitude information of point locations as illustrated in FIGS. 6A to 6C. In the illustrated examples, the display unit 105 displays altitudes 702 of point locations on the altitude display portion 105a, displays time points 703 at the point locations on the time display portion 105b, and displays “POINT1” to “POINT3” 701 indicating that altitude information of the point locations is displayed, on the information display portion 105c.

In a case where there are a plurality of point locations, the display unit 105 displays altitude information in a registered order. For example, it is assumed that “POINT1”, “POINT2”, and “POINT3” are registered in this order. In this case, if the key input means 104D receives a short-pressed input in the normal mode or when the display illustrated in FIG. 3 is performed, the display unit 105 displays altitude information of “POINT1” as illustrated in FIG. 6A.

If the key input means 104D receives a short-pressed input when the display illustrated in FIG. 6A is performed, the display unit 105 displays altitude information of “POINT2” as illustrated in FIG. 6B. In addition, if the key input means 104D receives a short-pressed input when the display illustrated in FIG. 6B is performed, the display unit 105 displays altitude information of “POINT3” as illustrated in FIG. 6C. Further, if the key input means 104D receives a short-pressed input when the display illustrated in FIG. 6C is performed, the display unit 105 displays altitude information of “POINT1” as illustrated in FIG. 6A.

In a case where the key input means 104D receives a long-pressed input when the display illustrated in FIGS. 6A to 6C is performed, or in a case where a predetermined time has elapsed after the display illustrated in FIGS. 6A to 6C starts, the display unit 105 performs the display illustrated in FIG. 3.

In the present embodiment, the CPU 101 displays altitude information of a point location if the key input means 104D receives a short-pressed input, and records altitude information of a point location if the key input means 104D receives a long-pressed input, but a point location registration operation and a point location display operation are not limited thereto. For example, the CPU 101 may display altitude information of a point location if the key input means 104B receives a short-pressed input, and may record altitude information of a point location if the key input means 104B receives a long-pressed input. Alternatively, the CPU 101 may record altitude information of a point location if the key input means 104A receives a short-pressed input, and may display altitude information of a point location if the key input means 104B receives a long-pressed input. In this case, the CPU 101 starts log recording in a case where the key input means 104A receives a long-pressed input, and stops the log recording in a case where the key input means 104A receives a long-pressed input during the log recording. In other words, a log starting operation, a log stopping operation, and a point location registration operation are performed through different button operations (a short-pressed input or a long-pressed input).

Next, a description will be made of a method of retrieving altitude information of a MAX location and altitude information of a MIN location. The CPU 101 retrieves altitude information of a MAX location or altitude information of a MIN location from the log file by using either the following (Method 1) or (Method 2).

(Method 1) The CPU 101 retrieves altitude information indicating the highest altitude from the log file stored in the RAM 110 when the key input means 104C receives an input, and sets the retrieved altitude information as altitude information of a MAX location. In addition, the CPU 101 retrieves altitude information indicating the lowest altitude from the log file stored in the RAM 110 when the key input means 104C receives an input, and sets the retrieved altitude information as altitude information of a MIN location.

(Method 2) The CPU 101 records altitude information of a starting location as altitude information of a MAX location and altitude information of a MIN location when a log starting operation is performed (when the key input means 104A receives an input). In addition, during an operation in the altitude log mode, the CPU 101 compares altitude information of a MAX location and altitude information of a MIN location which are currently recorded with the present altitude information when the altitude information is recorded. In a case where an altitude indicated by the present altitude information is higher than that indicated by the altitude information of the MAX location which is currently recorded, the CPU 101 overwrites the present altitude information to the log file as altitude information of the MAX location. Further, in a case where an altitude indicated by the present altitude information is lower than that indicated by the altitude information of the MIN location which is currently recorded, the CPU 101 overwrites the present altitude information to the log file as altitude information of the MIN location. The CPU 101 reads the altitude information of the MAX location or the altitude information of the MIN location which is recorded in the log file when the key input means 104C receives an input.

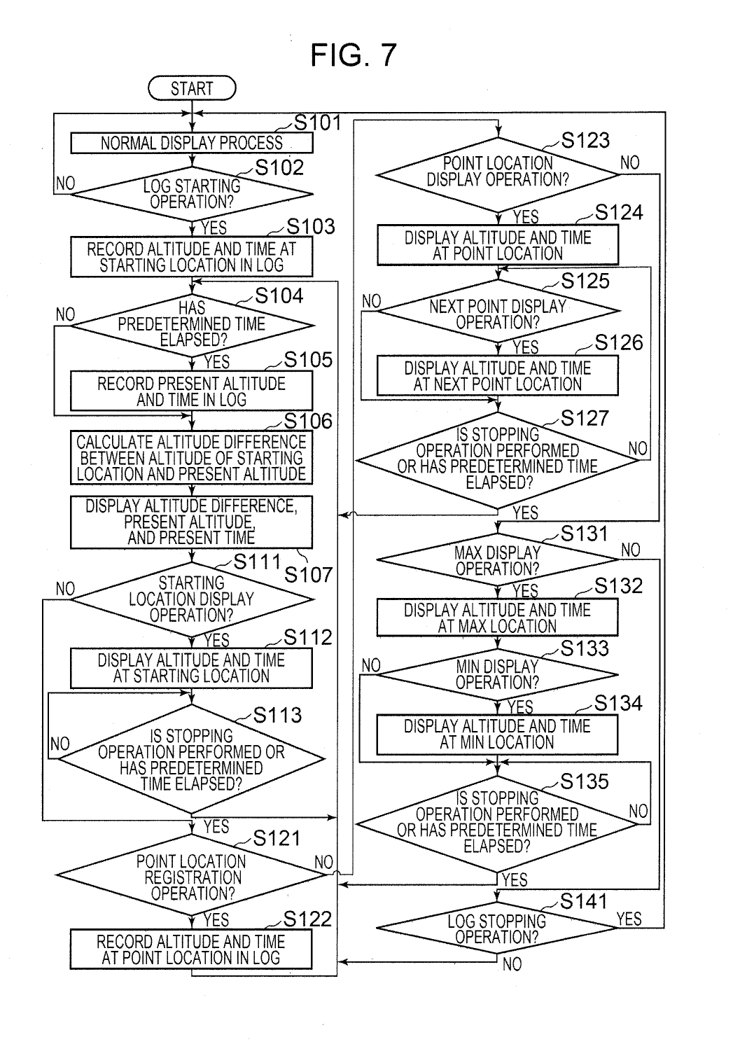

Next, a description will be made of an altitude recording process in which the electronic apparatus 100 according to the present embodiment records altitude information. FIG. 7 is a flowchart illustrating process procedures of an altitude recording process performed by the electronic apparatus 100 according to the present embodiment. The electronic apparatus 100 performs the illustrated altitude recording process when the electronic apparatus starts.

(Step S101) The CPU 101 starts in the normal mode, and performs a display process in the normal mode. Specifically, the CPU 101 displays an altitude measured by the altitude measurement unit 108 and the present time which is counted on the basis of a measurement signal which is input from the frequency dividing circuit 103, on the display unit 105. Next, the CPU proceeds to a process in step S102.

(Step S102) The CPU 101 determines whether or not a log starting operation input is received (the key input means 104A receives an input). If it is determined that the log starting operation input is not received (step S102: No), the CPU 101 returns to the process in step S101. On the other hand, if it is determined that the log starting operation input is received (step S102: Yes), the CPU 101 proceeds to the process in step S103.

(Step S103) The CPU 101 writes and records an altitude and a time when the log starting operation is received, to and in a log file stored in the RAM 110 as altitude information of a starting location. Then, the CPU proceeds to a process in step S104.

(Step S104) The CPU 101 determines whether or not a predetermined time (for example, one minute) has elapsed after last altitude information is recorded in the log file. If it is determined that the predetermined time has elapsed (step S104: Yes), the CPU 101 proceeds to a process in step S105. On the other hand, if it is determined that the predetermined time has not elapsed (step S104: No), the CPU 101 proceeds to a process in step S106.

(Step S105) The CPU 101 writes and records the present altitude and the present time to and in the log file as altitude information. Next, the CPU proceeds to a process in step S106.

(Step S106) The CPU 101 calculates a relative altitude difference between the present altitude and the altitude of the starting location. Specifically, the CPU 101 subtracts the altitude of the starting location from the present altitude. Next, the CPU proceeds to a process in step S107.

(Step S107) The CPU 101 displays the relative altitude difference calculated in step S106, the present altitude, and the present time on the display unit 105. Then, the CPU proceeds to a process in step S111.

(Step S111) The CPU 101 determines whether or not a starting location display operation input is received (the key input means 104B receives an input). If it is determined that the starting location display operation input is received (step S111: Yes), the CPU 101 proceeds to a process in step S112. On the other hand, if it is determined that the starting location display operation input is not received (step S111: No), the CPU 101 proceeds to a process in step S121.

(Step S112) The CPU 101 reads the altitude information of the starting location from the log file stored in the RAM 110, and displays the read altitude information (altitude and time) on the display unit 105. Next, the CPU proceeds to a process in step S113.

(Step S113) The CPU 101 determines whether or not a stopping operation input is received (the key input means 1045 receives an input), or determines whether or not a predetermined time has elapsed after the starting location display operation input is received. If it is determined that the stopping operation input is received, or it is determined that the predetermined time has elapsed after the starting location display operation input is received (step S113: Yes), the CPU 101 returns to the process in step S104. On the other hand, if it is determined that the stopping operation input is not received, and the predetermined time has not elapsed after the starting location display operation input is received (step S113: No), the CPU 101 returns to the process in step S113.

(Step S121) The CPU 101 determines whether or not a point location registration operation input is received (the key input means 104D receives a long-pressed input). If it is determined that the point location registration operation input is received (step S121: Yes), the CPU 101 proceeds to a process in step S122. On the other hand, if it is determined that the point location registration operation input is not received (step S121: No), the CPU 101 proceeds to a process in step S123.

(Step S122) The CPU 101 writes and records the present altitude and time to and in the log file stored in the RAM 110 as altitude information of a point location. Then, the CPU returns to the process in step S104.

(Step S123) The CPU 101 determines whether or not a point location display operation input is received (the key input means 104D receives a short-pressed input). If it is determined that the point location display operation input is received (step S123: Yes), the CPU 101 proceeds to a process in step S124. On the other hand, if it is determined that the point location display operation input is not received (step S123: No), the CPU 101 proceeds to a process in step S131.

(Step S124) The CPU 101 reads altitude information of the point location from the log file stored in the RAM 110, and displays the read altitude information (altitude and time) on the display unit 105. Next, the CPU proceeds to a process in step S125.

(Step S125) The CPU 101 determines whether or not the next point location display operation input is received (the key input means 104D receives a short-pressed input). If it is determined that the next point location display operation input is received (step S125: Yes), the CPU 101 proceeds to a process in step S126. On the other hand, if it is determined that the next point location display operation input is not received (step S125: No), the CPU 101 proceeds to a process in step S127.

(Step S126) The CPU 101 reads altitude information of the next point location from the log file stored in the RAM 110, and displays the read altitude information (altitude and time) on the display unit 105. In addition, in a case where there is no next point location, the CPU 101 displays altitude information of the first point location on the display unit 105. Next, the CPU proceeds to a process in step S127.

(Step S127) The CPU 101 determines whether or not a stopping operation input is received (the key input means 104D receives a long-pressed input), or determines whether or not a predetermined time has elapsed after the point location display operation input is received. If it is determined that the stopping operation input is received or the predetermined time has elapsed after the point location display operation input is received (step S127: Yes), the CPU 101 returns to the process in step S104. On the other hand, if it is determined that the stopping operation input is not received, and the predetermined time has not elapsed after the point location display operation input is received (step S127: No), the CPU 101 returns to the process in step S125.

(Step S131) The CPU 101 determines whether or not a MAX display operation input is received (the key input means 104C receives an input). If it is determined that the MAX display operation input is received (step S131: Yes), the CPU 101 proceeds to a process in step S132. On the other hand, if it is determined that the MAX display operation input is not received (step S131: No), the CPU 101 proceeds to a process in step S141.

(Step S132) The CPU 101 reads altitude information of the MAX location from the log file stored in the RAM 110, and displays the read altitude information (altitude and time) on the display unit 105. Next, the CPU proceeds to a process in step S133.

(Step S133) The CPU 101 determines whether or not a MIN display operation input is received (the key input means 104C receives an input). If it is determined that the MIN display operation input is received (step S133: Yes), the CPU 101 proceeds to a process in step S134. On the other hand, if it is determined that the MIN display operation input is not received (step S133: No), the CPU 101 proceeds to a process in step S135.

(Step S134) The CPU 101 reads altitude information of the MIN location from the log file stored in the RAM 110, and displays the read altitude information (altitude and time) on the display unit 105. Next, the CPU proceeds to a process in step S135.

(Step S135) The CPU 101 determines whether or not a stopping operation input is received (the key input means 104C receives an input), or determines whether or not a predetermined time has elapsed after the MAX location display operation input is received. If it is determined that the stopping operation input is received or the predetermined time has elapsed after the MAX location display operation input is received (step S135: Yes), the CPU 101 returns to the process in step S104. On the other hand, if it is determined that the stopping operation input is not received, and the predetermined time has not elapsed after the MAX location display operation input is received (step S135: No), the CPU 101 returns to the process in step S135.

(Step S141) The CPU 101 determines whether or not a log stopping operation input is received (the key input means 104A receives an input). If it is determined that the log stopping operation input is received (step S141: Yes), the CPU 101 stops log recording and returns to the process in step S101. On the other hand, if it is determined that the log stopping operation input is not received (step S141: No), the CPU 101 returns to the process in step S104.

As described above, in the present embodiment, the CPU 101 records altitude information in the log file at a predetermined time interval in the altitude log mode. In addition, the CPU 101 displays an altitude and a time at a starting location in the altitude log mode when a starting location display operation is performed. Accordingly, a user can instantaneously grasp information on an altitude or a time point at a start time through a single button operation during mountain climbing (altitude log mode), and thus can utilize the information for a climbing pace or planning.

In addition, in the present embodiment, the CPU 101 displays an altitude and a time at a MAX location when a MAX display operation input is received, and displays an altitude and a time at a MIN location when a MIN display operation input is received. Accordingly, a user can grasp the highest altitude and an arrival time thereof during mountain climbing, or the lowest altitude and an arrival time thereof during mountain climbing.

Further, in the present embodiment, when a point location registration operation input is received, the CPU 101 registers the present altitude and time as altitude information of a point location. Furthermore, when a point location display operation input is received, the CPU 101 displays the altitude and the time at the point location. Accordingly, a user can grasp an altitude of each point location registered during mountain climbing or an arrival time thereof.

### Second Embodiment

Next, a second embodiment of the present invention will be described. A configuration of an electronic apparatus 100 according to the present embodiment is the same as the configuration of the electronic apparatus 100 according to the first embodiment illustrated in FIGS. 1 and 2. A difference between the present embodiment and the first embodiment is that the electronic apparatus 100 changes display of the display unit 105 in an order of an ascending average climbing speed, a descending average climbing speed, altitude information of a starting location, energy consumption, altitude information of a MAX location, and altitude information of a MIN location each time the key input means 104 receives an input for instructing display of altitude information (for example, the key input means 104B receives an input) in the altitude log mode. The climbing speed is a movement speed regarding an altitude, and is a movement difference in elevation per unit time. The average climbing speed is an average value of climbing speeds. The ascending average climbing speed is an average climbing speed in an ascending state (when an altitude increases). The descending average climbing speed is an average climbing speed in a descending state (when an altitude decreases). The energy consumption is energy which is consumed by a user due to mountain climbing from the time of starting of recording of altitude information to the present time.

The CPU 101 calculates a climbing speed on the basis of recorded altitude information (elapsed time and altitude). Specifically, the CPU 101 calculates a climbing speed by dividing an altitude difference between an altitude at the time of starting of recording and the present altitude by an elapsed time. In addition, the CPU 101 determines an ascending state in a case where a recorded altitude is higher than a previously recorded altitude. The CPU 101 calculates an ascending average climbing speed on the basis of altitude information in an ascending state. Further, the CPU 101 determines a descending state in a case where a recorded altitude is lower than a previously recorded altitude. The CPU 101 calculates a descending average climbing speed on the basis of altitude information in a descending state. Furthermore, the CPU 101 calculates energy consumption on the basis of recorded altitude information or climbing speed (movement speed).

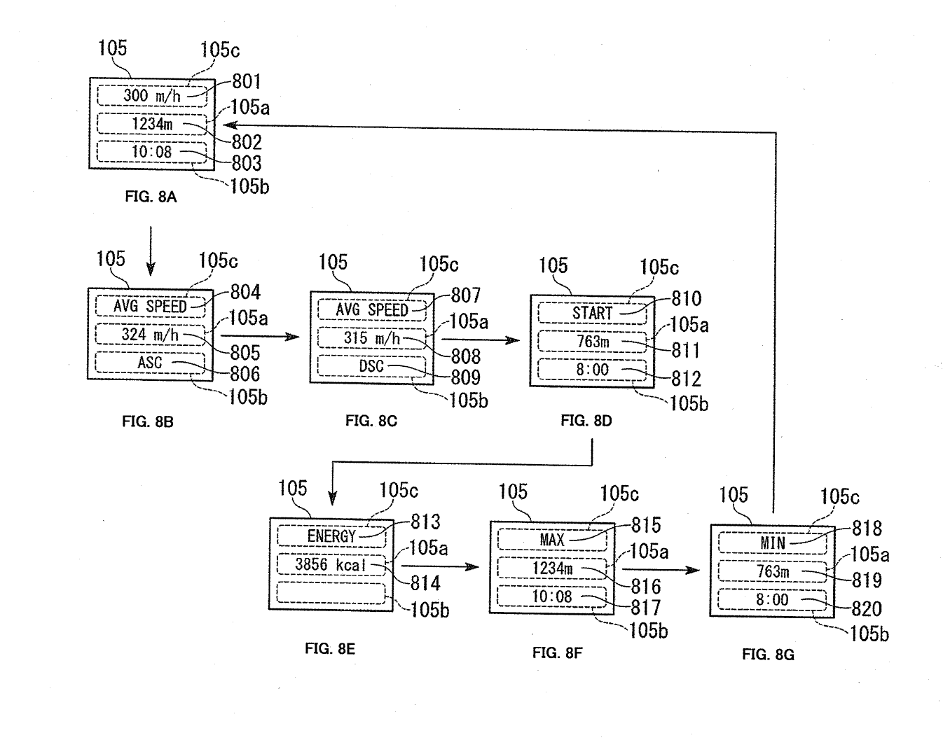

FIGS. 8A to 8G are schematic diagrams illustrating a screen transition of the display unit 105 in the present embodiment. FIG. 8A is a schematic diagram illustrating information which is displayed on the display unit 105 by the CPU 101 according to the present embodiment in the altitude log mode. In an illustrated example, the display unit 105 displays the present altitude “1234 m” 802 on the altitude display portion 105a, displays the present time “10:08” 803 on the time display portion 105b, and displays a climbing speed “300 m/h” 801 on the information display portion 105c.

If the key input means 104 receives an input for instructing display of altitude information when the display illustrated in FIG. 8A is performed, the CPU 101 displays an ascending average climbing speed on the display unit 105 (refer to FIG. 8B). In an illustrated example, the display unit 105 displays an ascending climbing speed “324 m/h” 805 on the altitude display portion 105a, displays “ASC” 806 indicating an ascending state on the time display portion 105b, and displays an average climbing speed “AVG SPEED” 804 on the information display portion 105c.

If the key input means 104 receives an input for instructing display of altitude information when the display illustrated in FIG. 8B is performed, the CPU 101 displays a descending average climbing speed on the display unit 105 (refer to FIG. 8C). In an illustrated example, the display unit 105 displays a descending average climbing speed “315 m/h” 808 on the altitude display portion 105a, displays “DSC” 809 indicating a descending state on the time display portion 105b, and displays an average climbing speed “AVG SPEED” 807 on the information display portion 105c.

If the key input means 104 receives an input for instructing display of altitude information when the display illustrated in FIG. 8C is performed, the CPU 101 displays altitude information of a starting location on the display unit 105 (refer to FIG. 8D). In an illustrated example, the display unit 105 displays an altitude “763 m” 811 of the starting location on the altitude display portion 105a, displays a time point “8:00” 812 at the starting location on the time display portion 105b, and displays “START” 810 indicating that the altitude information of the starting location is displayed, on the information display portion 105c.

If the key input means 104 receives an input for instructing display of altitude information when the display illustrated in FIG. 8D is performed, the CPU 101 displays energy consumption on the display unit 105 (refer to FIG. 8E). In an illustrated example, the display unit 105 displays energy consumption “3856 kcal” 814 on the altitude display portion 105a, and displays “ENERGY” 813 indicating that energy consumption is displayed, on the information display portion 105c.

If the key input means 104 receives an input for instructing display of altitude information when the display illustrated in FIG. 8E is performed, the CPU 101 displays altitude information of a MAX location on the display unit 105 (refer to FIG. 8F). In an illustrated example, the display unit 105 displays an altitude “1234 m” 816 of the MAX location on the altitude display portion 105a, displays a time point “10:08” 817 at the MAX location on the time display portion 105b, and displays “MAX” 815 indicating that altitude information of the MAX location is displayed, on the information display portion 105c.

If the key input means 104 receives an input for instructing display of altitude information when the display illustrated in FIG. 8F is performed, the CPU 101 displays altitude information of a MIN location on the display unit 105 (refer to FIG. 8G). In an illustrated example, the display unit 105 displays an altitude “763 m” 819 of the MIN location on the altitude display portion 105a, displays a time point “8:00” 820 at the MIN location on the time display portion 105b, and displays “MIN” 818 indicating that altitude information of the MIN location is displayed, on the information display portion 105c. If the key input means 104 receives an input for instructing display of altitude information when the display illustrated in FIG. 8G is performed, the CPU 101 returns the display of the display unit 105 to FIG. 8A.

In addition, in the present embodiment, the CPU 101 changes display of the display unit 105 each time the key input means 104 receives an input for instructing display of altitude information, but is not limited thereto, and may automatically change display of the display unit 105 in an order of an ascending average climbing speed, a descending average climbing speed, altitude information of a starting location, energy consumption, altitude information of a MAX location, and altitude information of a MIN location at a predetermined time interval if the key input means 104B receives an input once.

In addition, in the present embodiment, the CPU 101 changes display of the display unit 105 in an order of an ascending average climbing speed, a descending average climbing speed, altitude information of a starting location, energy consumption, altitude information of a MAX location, and altitude information of a MIN location each time the key input means 104 receives an input for instructing display of altitude information, but a display order or a combination of displayed information is not limited thereto. For example, the CPU 101 may change display of the display unit 105 in an order of an ascending average climbing speed, a descending average climbing speed, altitude information of a starting location, and energy consumption. Alternatively, the CPU 101 may change display of the display unit 105 in an order of an ascending average climbing speed, a descending average climbing speed, energy consumption, altitude information of a MAX location, and altitude information of a MIN location. Alternatively, the CPU 101 may change display of the display unit 105 in an order of an ascending average climbing speed, a descending average climbing speed, energy consumption, and altitude information of a point location.

As described above, in the present embodiment, the CPU 101 displays a climbing speed on the display unit 105 in the altitude log mode. Accordingly, a user can grasp his/her climbing speed. In addition, if the key input means 104 receives an input for instructing display of altitude information, the CPU 101 displays an average climbing speed on the display unit 105. Therefore, the user can grasp an ascending average climbing speed or a descending average climbing speed. Particularly, the user can easily grasp a necessary time for going down a mountain during mountain climbing by viewing both of the descending average climbing speed and the altitude when the recording starts.

Further, in the present embodiment, if the key input means 104 receives an input for instructing display of altitude information in the altitude log mode, the CPU 101 displays energy consumption on the display unit 105. Accordingly, since the user can grasp to what extent energy is consumed during mountain climbing, the energy consumption information can be used as a reference for predicting timing of rest or energy (food) supply.

In the present embodiment, the CPU 101 changes information displayed on the display unit 105 each time the key input means 104 receives an input for instructing display of altitude information. Accordingly, since each information piece can be displayed on the display unit 105 through a single button operation, it is possible to prevent an operation related to display from being complex.

In addition, all or some of the functions of the respective units of the electronic apparatus 100 according to the above-described embodiments may be realized by recording a program for realizing the functions on a computer readable recording medium and by a computer system reading and executing the program recorded on the recording medium. Further, the “computer system” mentioned here is assumed to include an OS or hardware such as peripheral devices.

The “computer readable recording medium” refers to a portable medium such as a flexible disk, a magneto-optical disc, a ROM, or a CD-ROM, and a storage part such as a hard disk built into the computer system. In addition, the “computer readable recording medium” may include a medium which dynamically holds a program for a short time, such as a communication line in a case where the program is transmitted via a network such as the Internet or a communication channel such as a telephone channel, and a medium which holds the program during a specific period, such as a volatile memory of the computer system serving as a server or a client in that case. Further, the program may realize some of the above-described functions, and may realize the above-described functions through a combination with a program which has already been recorded on the computer system.

As mentioned above, the embodiments of the present invention have been described, but the present invention is not limited to the embodiments and may have various modifications within the scope without departing from the spirit of the present invention. For example, in the above-described embodiment, the electronic apparatus 100 is an electronic timepiece, but is not limited thereto, and the electronic apparatus 100 may be an altimeter or other electronic apparatuses such as a smart phone having an altitude measurement function.

In addition, a log starting operation, a log stopping operation, a starting location display operation, a MAX location display operation, a MIN location display operation, or a point location display operation may be performed through various button operations (combinations of the kinds of buttons (any one of the key input means 104A to 104D) and a press pattern such as short-pressed input/long-pressed input or the number of times of pressing).

What is claimed is:

1. An electronic apparatus comprising:
a display unit;
an altitude measurement unit that measures an altitude;
an operation unit that receives an operation input;
a recording unit that starts recording of altitude information regarding an altitude measured by the altitude measurement unit at a predetermined time interval if the operation unit receives an input for instructing starting of recording of an altitude, and stops the recording of the altitude information if the operation unit receives an input for instructing stopping of recording of an altitude; and
a display control unit that displays the altitude information when the recording starts on the display unit among the altitude information pieces recorded by the recording unit if the operation unit receives an input for instructing display of the altitude information in a state in which the recording unit currently records the altitude information.

2. The electronic apparatus according to claim 1,
wherein the display control unit displays a climbing speed which is a movement speed regarding an altitude calculated from the altitude information recorded by the recording unit on the display unit if the operation unit receives an input for instructing display of the altitude information in a state in which the recording unit currently records the altitude information.

3. The electronic apparatus according to claim 2,
wherein the climbing speed includes an average climbing speed regarding an ascending state or an average climbing speed regarding a descending state.

4. The electronic apparatus according to claim 1,
wherein the display control unit displays altitude information indicating a maximal altitude or altitude information indicating a minimal altitude on the display unit among the altitude information pieces recorded by the recording unit if the operation unit receives an input for instructing display of the altitude information in a state in which the recording unit currently records the altitude information.

5. The electronic apparatus according to claim 2,
wherein the display control unit displays altitude information indicating a maximal altitude or altitude information indicating a minimal altitude on the display unit among the altitude information pieces recorded by the recording unit if the operation unit receives an input for instructing display of the altitude information in a state in which the recording unit currently records the altitude information.

6. The electronic apparatus according to claim 3,
wherein the display control unit displays altitude information indicating a maximal altitude or altitude information indicating a minimal altitude on the display unit among the altitude information pieces recorded by the recording unit if the operation unit receives an input for instructing display of the altitude information in a state in which the recording unit currently records the altitude information.

7. The electronic apparatus according to claim 1,
wherein the recording unit records the present altitude information as the altitude information of a point location if the operation unit receives an input for instructing recording of the altitude information of the point location, and
wherein the display control unit displays the altitude information of the point location on the display unit if the operation unit receives an input for instructing display of the altitude information in a state in which the recording unit currently records the altitude information.

8. The electronic apparatus according to claim 2,
wherein the recording unit records the present altitude information as the altitude information of a point location if the operation unit receives an input for instructing recording of the altitude information of the point location, and
wherein the display control unit displays the altitude information of the point location on the display unit if the operation unit receives an input for instructing display of the altitude information in a state in which the recording unit currently records the altitude information.

9. The electronic apparatus according to claim 3,
wherein the recording unit records the present altitude information as the altitude information of a point location if the operation unit receives an input for instructing recording of the altitude information of the point location, and
wherein the display control unit displays the altitude information of the point location on the display unit if the operation unit receives an input for instructing display of the altitude information in a state in which the recording unit currently records the altitude information.

10. The electronic apparatus according to claim 4,
wherein the recording unit records the present altitude information as the altitude information of a point location if the operation unit receives an input for instructing recording of the altitude information of the point location, and
wherein the display control unit displays the altitude information of the point location on the display unit if the operation unit receives an input for instructing display of the altitude information in a state in which the recording unit currently records the altitude information.

11. The electronic apparatus according to claim 5,
wherein the recording unit records the present altitude information as the altitude information of a point location if the operation unit receives an input for instructing recording of the altitude information of the point location, and
wherein the display control unit displays the altitude information of the point location on the display unit if the operation unit receives an input for instructing display of the altitude information in a state in which the recording unit currently records the altitude information.

12. The electronic apparatus according to claim 6,
wherein the recording unit records the present altitude information as the altitude information of a point location if the operation unit receives an input for instructing recording of the altitude information of the point location, and
wherein the display control unit displays the altitude information of the point location on the display unit if the operation unit receives an input for instructing display of the altitude information in a state in which the recording unit currently records the altitude information.

13. A program causing a computer to perform:
measuring an altitude;
starting recording of altitude information regarding the measured altitude at a predetermined time interval if an operation unit which receives an operation input receives an input for instructing starting of recording of an altitude;
recording the present altitude information as the altitude information of a point location if the operation unit receives an input for instructing recording of the altitude information of the point location;
displaying the altitude information when the recording starts, a climbing speed which is a movement speed regarding an altitude calculated from the altitude information, the altitude information indicating a maximal altitude among the altitude information pieces, the altitude information indicating a minimal altitude among the altitude information pieces, or the altitude information of the point location on a display unit if the operation unit receives an input for instructing display of the altitude information in a state in which the altitude information is currently recorded; and
stopping the recording of the altitude information if the operation unit receives an input for instructing stopping of recording of an altitude.
